(19) United States
(12) Patent Application Publication
(10) Pub. No.: US 2024/0250250 A1
(43) Pub. Date: Jul. 25, 2024

(54) ELECTRODE FOR METAL BATTERY INCLUDING METAL STORAGE HOST AND METAL BATTERY INCLUDING THE SAME

(71) Applicant: UIF (University Industry Foundation), Yonsei University, Seoul (KR)

(72) Inventors: Sang-Young Lee, Seoul (KR); Seung-Hyeok Kim, Seoul (KR)

(73) Assignee: UIF (University Industry Foundation), Yonsei University, Seoul (KR)

(21) Appl. No.: 18/396,777

(22) Filed: Dec. 27, 2023

(30) Foreign Application Priority Data
Jan. 25, 2023 (KR) 10-2023-0009458

(51) Int. Cl. H01M 4/38; H01M 4/04; H01M 4/60; H01M 10/00

(52) U.S. Cl. CPC H01M 4/382; H01M 4/0438; H01M 4/60; H01M 10/00; H01M 2004/021

(57) ABSTRACT

The present disclosure relates to an electrode for a metal battery, including: a current collector; and an active material layer disposed on the current collector and including a metal storage host, wherein the metal storage host includes a metal-containing aromatic compound, and a metal battery including the same. The electrode for a metal battery inhibits dendrite growth on the electrode to provide the battery with improved electrochemical performance and life.

### CROSS-REFERENCE TO RELATED APPLICATION

This application claims priority to Korean Patent Application No. 10-2023-0009458 filed on Jan. 25, 2023, and all the benefits accruing therefrom under 35 U.S.C. § 119, the contents of which in its entirety are herein incorporated by reference.

### BACKGROUND

### 1. Field

The present disclosure relates to an electrode for a metal battery including a metal storage host, and a metal battery including the same. More particularly, the present disclosure relates to an electrode for a metal battery which inhibits dendrite growth occurring in the electrode for a metal battery to provide improved electrochemical performance and life, and a metal battery including the same.

### 2. Description of the Related Art

Lithium secondary batteries have high energy density and excellent output characteristics among various secondary batteries, and thus have high availability. Among such lithium secondary batteries, metal batteries having higher capacity and high energy density characteristics as compared to lithium-ion batteries have been increasingly in demand. A metal battery including a metal electrode, such as lithium, zinc or magnesium, can realize a capacity at least 10 times higher than the capacity of graphite used conventionally as a negative electrode material for a lithium-ion battery, and thus can remarkably improve the energy density of the battery.

However, in the case of the metal electrode, dendrite growth may occur, wherein non-uniform current distribution is induced on the electrode surface during the charge/discharge cycles of the battery to cause local concentration of metal deposition on the electrode. When metal is deposited non-uniformly, the metal is increasingly in contact with the electrolyte, and a new solid-electrolyte interphase (SEI) layer is formed due to the side reactions of the electrolyte with the metal to cause depletion of the electrolyte and lithium. Therefore, dendrite growth not only causes an internal short-circuit of the battery but also induces severe volumetric swelling of the electrode, and may result in degradation of the battery life and risks, such as fire accidents and explosion.

Under these circumstances, many studies have been conductive about a metal host capable of inhibiting dendrite growth of metal. For example, according to the related art, a metal negative electrode was obtained by modifying a current collector with a metal storage structure including an electrochemically inactive carbon-based material or alloying-based metallic material, and then injecting electrochemically deposited, pressed or molten lithium to the current collector. The method is advantageous in that it provides a battery with improve life characteristics by thermodynamically controlling the nucleation and growth of deposited metal or controlling the morphology of a host-metal composite. However, most metal negative electrodes using the above-mentioned metal storage structure are thick or heavy and hardly satisfy energy density per volume and weight, and thus show low practical availability. In addition, the carbon-based material has low affinity to lithium and makes it difficult to perform uniform metal deposition, the electrochemically inactive material is in an electrochemically inert state to reduce the unit energy density of a cell, or the alloying-based material shows electrochemical activity but has a limitation of poor life characteristics due to its large change in volume.

Therefore, there is a need for research and development about an electrode for a metal battery which can inhibit dendrite growth occurring on the electrode for a metal battery, provides high energy density per volume and weight and can improve the electrochemical performance.

### SUMMARY

The present disclosure is directed to providing an electrode for a metal battery which can inhibit dendrite growth, and a metal battery including the same.

In addition, the electrode for a metal battery and the metal battery including the same can significantly reduce the volumetric swelling of the electrode even after repeating charge/discharge cycles.

In one aspect, there is provided an electrode for a metal battery, including: a current collector; and an active material layer disposed on the current collector and including a metal storage host, wherein the metal storage host includes a metal-containing aromatic compound.

In the electrode for a metal battery according to the present disclosure, the metal in the metal-containing aromatic compound may include lithium.

In the electrode for a metal battery according to the present disclosure, the metal-containing aromatic compound may include an aromatic polyhydric metal carboxylate.

In the electrode for a metal battery according to the present disclosure, the aromatic polyhydric carboxylic acid of the aromatic polyhydric metal carboxylate may include at least one selected from the group consisting of phthalic acid (PA), isophthalic acid (IPA), terephthalic acid (PTA) and naphthalene-2,6-dicarboxylic acid.

In the electrode for a metal battery according to the present disclosure, the active material layer may further include a conductive material and a binder.

In the electrode for a metal battery according to the present disclosure, the active material layer may have a thickness of 1-100 μm.

In the electrode for a metal battery according to the present disclosure, the metal electrode may further include metal foil disposed on the active material layer.

In the electrode for a metal battery according to the present disclosure, the metal foil may have a thickness of 3-18 nm.

In the electrode for a metal battery according to the present disclosure, the metal foil may include lithium.

In the electrode for a metal battery according to the present disclosure, the metal foil may be deposited through an electrochemical process.

In another aspect, there is provided a metal battery including: a negative electrode that includes a metal storage host including a metal-containing aromatic compound; a positive electrode disposed to face the negative electrode while being spaced apart from the negative electrode; and an electrolyte that is in contact with the positive electrode and the negative electrode.

In the metal battery according to the present disclosure, the metal-containing aromatic compound may include an aromatic polyhydric metal carboxylate.

In the metal battery according to the present disclosure, the aromatic polyhydric carboxylic acid of the aromatic polyhydric metal carboxylate may include a C6-C20 aromatic group and 2-4 carboxylate groups.

In the metal battery according to the present disclosure, the electrolyte may include at least one selected from the group consisting of an organic electrolyte, an ionic liquid electrolyte, a gel electrolyte, a polymer electrolyte and an inorganic electrolyte.

In the metal battery according to the present disclosure, the metal battery may further include a separator interposed between the positive electrode and the negative electrode.

According to the electrode for a metal battery according to the present disclosure and a metal battery including the same, it is possible to inhibit dendrite growth in the electrode and thus to reinforce the life and stability of the battery.

In addition, the metal storage host contained in the electrode substantially contributes to the capacity, and thus it is possible to provide a metal battery having improved electrochemical performance.

### BRIEF DESCRIPTION OF THE DRAWINGS

FIG. 1 is a schematic view illustrating the process for manufacturing the electrode for a metal battery according to an embodiment of the present disclosure.

FIG. 2 is a high-resolution transmission electron microscopic (HR-TEM) image of the electrode for a metal battery according to an embodiment of the present disclosure.

FIG. 3 is an image of the electrode for a metal battery according to an embodiment of the present disclosure, as observed by electron energy loss spectroscopy (EELS).

FIG. 4 is a graph illustrating a change in capacity depending on the charge/discharge of the electrode for a metal battery according to an embodiment of the present disclosure.

FIGS. 5A and 5B are graphs illustrating the electrochemical performance of the metal battery according to an embodiment of the present disclosure.

### DETAILED DESCRIPTION

Hereinafter, the electrode for a metal battery including a metal storage host according to the present disclosure and a metal battery including the same will be explained in more detail. Terms used in this specification were selected as widely used general terms as possible in consideration of the functions of the present disclosure, but this may vary depending on the intention or precedent of a technician in the related field, the emergence of new technologies, or the like. If there is no other definition in the technical terms and scientific terms used herein, the terms may have meanings understood generally by those skilled in the art.

It will be further understood that the terms “include” and/or “including”, “comprise” and/or “comprising”, or “have” and/or “having” when used in this specification, do not preclude the presence of other features or elements but specify the additional presence of other features or elements, unless otherwise stated.

As used herein, the singular forms “a”, “an” and “the” are intended to include the plural forms as well, unless the context clearly indicates otherwise. In addition, the plural forms are intended to include the singular forms, unless the context clearly indicates otherwise.

In addition, the numerical range used in the specification may include all possible combinations of lower and upper limits and all values within the range, logically derived increments in the form and width of the defined range, double-limited all values, and upper and lower limits of the numerical range limited to different forms. Values other than the numerical range that are likely to occur due to experimental errors or rounding of values are also included in the defined numerical range unless otherwise stated in the specification.

The term “about” used in this specification and the appended claims is used to cover the tolerance when the tolerance exists.

A metal battery is advantageous in that it has a theoretical capacity about 10 times higher than the theoretical capacity of a general lithium-ion battery, but is problematic in that a non-uniform current distribution is induced on the electrode surface during charge/discharge to cause local deposition of metal on the electrode and dendrite growth. When dendrite is formed, the contact area between the electrolyte and metal is increased to form a solid electrolyte interphase layer due to the side reactions between the electrolyte and metal, resulting in depletion of the electrolyte and lithium. Therefore, such dendrite may be a cause of severe volumetric swelling of the electrode, may result in an increase in the resistance of the battery, generation of an internal short-circuit and degradation of life, and may cause risks of fire accident and explosion.

To overcome the above-mentioned problems, attentions have been given to studies for developing a metal battery in which dendrite growth is inhibited by introducing a metal storage structure including a carbon-based porous body or alloying-based metal to an electrode. However, such a metal storage structure has low affinity to lithium and makes it difficult to deposit the metal uniformly, and has a limitation in realizing a high-energy density metal battery due to the large weight and volume, even though it does not directly participate in energy storage.

The electrode for a metal battery according to the present disclosure includes: a current collector; and an active material layer disposed on the current collector and including a metal storage host, wherein the metal storage host includes a metal-containing aromatic compound.

The active material layer disposed on the current collector can inhibit dendrite growth of the electrode though the host capable of storing and releasing a metal. Particularly, the metal storage host includes a metal-containing aromatic compound, which may include an aromatic polyhydric metal carboxylate. The aromatic polyhydric metal carboxylate is advantageous in that it has excellent electrochemical, thermal and structural stability, occupies smaller volume as compared to the conventional porous metal storage structure to provide a high capacity per weight and volume, and has a redox potential applicable to the electrode material of a battery to allow reversible metal deposition/detachment depending on the electrochemical reactions of the metal.

According to an embodiment of the present disclosure, the aromatic polyhydric metal carboxylate may be a divalent to tetravalent metal carboxylate. Particularly, the aromatic polyhydric carboxylate may include at least one selected from the group consisting of phthalic acid (PA), isophthalic acid (IPA), terephthalic acid (PTA) and naphthalene-2,6-dicarboxylic acid, and the metal of the aromatic polyhydric metal carboxylate may include at least one selected from the group consisting of lithium (Li), sodium (Na), potassium (K), zinc (Zn), magnesium (Mg) and aluminum (AI), preferably lithium (Li).

More particularly, the aromatic polyhydric metal carboxylate may include lithium terephthalate (Li₂TP). Lithium terephthalate, which is a small molecule, provides a high energy density per weight and volume and thus can directly contribute to the improvement of the capacity of a battery. In addition, lithium terephthalate undergoes low volumetric swelling even after repeating charge/discharge cycles, and thus can improve the durability and life of a battery. Besides the above-mentioned advantages, terephthalate can be obtained by recycling polyethylene terephthalate (PET), and its raw material can be obtained easily with a low energy consumption, thereby providing advantages in terms of eco-friendly and cost-efficient characteristics.

According to an embodiment of the present disclosure, the active material layer may have a thickness of 1-100 μm, 3-80 μm, 5-60 μm, 10-50 μm, or 14-40 μm, practically 18-30 μm. In a variant, the thickness of the active material layer may be 1 μm or more, 5 μm or more, 10 μm or more, 15 μm or more, or 20 μm or more, and the upper limit may be 100 μm or less, 80 μm or less, 60 μm or less, 50 μm or less, 40 μm or less, or 20 μm or less. When the active material layer has a thickness within the above-defined range, it is possible to easily store the metal deposited through the charge of a battery and to rapidly release the metal during the discharge of the battery.

According to an embodiment of the present disclosure, the active material layer may further include a conductive material and a binder. Any conductive material may be used with no particular limitation, as long as it has conductivity while not causing any chemical change in the battery. Particular examples of the conductive material include: carbon black, such as acetylene black, ketjen black, channel black, furnace black, lamp black, thermal black, or the like; conductive fibers, such as carbon fibers or metal fibers; carbon fluoride; metal powder, such as aluminum, nickel, or the like; conductive whiskers, such as zinc oxide, potassium titanate, or the like; conductive materials, such as polyphenylene derivatives; or the like. The binder may include a fluorinated resin, such as polyvinylidene fluoride (PVDF), but the scope of the present disclosure is not limited thereto.

According to an embodiment of the present disclosure, the current collector may include nickel or copper that is electrochemically inactive in the operation range of the electrode, but the scope of the present disclosure is not limited to any particular type of current collector.

The electrode for a metal battery may further include metal foil disposed on the active material layer. Such metal foil may be formed through an electrochemical process during the manufacture of the electrode. The metal foil may be reversibly deposited onto and detached from the active material layer, while the metal is ionized and deposited on the active material layer during charge and is detached from the active material layer during discharge.

The metal foil may include at least one selected from the group consisting of lithium (Li), sodium (Na), potassium (K), zinc (Zn), magnesium (Mg) and aluminum (AI), preferably lithium (Li). The metal foil may include the same type of metal as or a different type of metal from the metal of the aromatic polyhydric metal carboxylate contained in the active material layer. However, when the metal foil includes the same type of metal, there is an advantage in that the metal may be deposited to a uniform thickness on the active material layer.

In general, a copper current collector shows a rough surface and has no affinity to lithium, and thus lithium can be locally deposited on the current collector during charge/discharge cycles. Since lithium ions are grown in one direction from the surface, lithium is non-uniformly deposited, while being grown from lithium nuclei formed locally on the current collector in the early stage, thereby accelerating dendrite growth. On the contrary, when the active material layer includes an aromatic polyhydric metal carboxylate including the same type of metal as the metal deposited on the current collector, the metal distributed throughout the active material layer provides uniform nucleation sites and the metal is deposited uniformly on the active material layer, thereby inhibiting dendrite growth.

According to an embodiment of the present disclosure, the metal foil may have a thickness of 3-18 nm, 4-16 nm, 5-14 nm, 6-12 nm, or 7-10 nm. In a variant, the metal foil may have a thickness of 3 nm or more, 5 nm or more, 7 nm or more, or 9 nm or more, and the upper limit of the thickness may be 20 nm or less, 18 nm or less, 16 nm or less, 14 nm or less, 12 nm or less, or 10 nm or less. When the metal is uniformly and thinly deposited on the active material layer, the battery shows an increased capacity per volume and weight occupied by the electrode. In this manner, it is possible to realize an electrode for a metal battery capable of maximizing the efficiency and energy density of the battery.

In the description of the metal battery according to the present disclosure, the ingredients, structure and shape or size of the negative electrode contained in the metal battery are the same as or similar to the above-described electrode for a metal battery. Therefore, all of the above description of the electrode for a metal battery will be incorporated the metal battery according to the present disclosure.

In another aspect of the present disclosure, there is provided a metal battery including: a negative electrode that includes a metal storage host including a metal-containing aromatic compound; a positive electrode disposed to face the negative electrode while being spaced apart from the negative electrode; and an electrolyte that is in contact with the positive electrode and the negative electrode.

The metal battery refers to a secondary battery including a metal as a negative electrode material, wherein the metal may include at least one selected from the group consisting of lithium (Li), sodium (Na), potassium (K), zinc (Zn), magnesium (Mg) and aluminum (AI). Preferably, the metal battery may be a lithium metal battery including lithium. Lithium shows a low standard reduction potential. Therefore, when manufacturing a battery by using lithium, it is possible to realize a high voltage and to obtain a metal battery having a high energy density advantageously.

Particularly, lithium may be deposited and formed on the negative electrode through an electrochemical process. When a metal battery is charged, lithium ions migrate toward the negative electrode and lithiation occurs on the negative electrode surface, and then lithium may be deposited on the negative electrode surface. According to the related art, lithium was deposited non-uniformly on the negative electrode during the deposition of lithium, thereby causing dendrite growth of lithium. While dendrite growth occurs and the contact area is increased, side reactions between the electrolyte and lithium are increased to cause depletion of the electrolyte. In addition, the deposited metal may be separated partially due to the dendrite growth, thereby generating dead lithium that loses an electrical contact with the current collector. Such dendrite growth and generation of dead lithium, caused by such non-uniform deposition of lithium, cause an increase in the resistance of the battery, resulting in the problems of generation of a short-circuit and degradation of the life and durability. Under these circumstances, when the negative electrode includes a metal-containing aromatic compound, the metal contained in the aromatic compound provides uniform nucleation sites so that the metal may be deposited uniformly and smoothly, which is effective for inhibiting dendrite growth.

According to an embodiment of the present disclosure, the metal-containing aromatic compound may include an aromatic polyhydric metal carboxylate. Particularly, the aromatic polyhydric carboxylic acid of the aromatic polyhydric metal carboxylate may include a C6-C20, C6-C14 or C6-C12 aromatic group and 2-4 carboxylate groups.

The aromatic polyhydric metal carboxylate is advantageous in that it includes a conjugated structure in which a double bond and a single bond are present alternately to provide excellent electrochemical, thermal and structural stability, can store and release a metal to be deposited, and has a redox potential applicable to a negative electrode material and reacts with the metal deposited during charge/discharge cycles to contribute to improvement of the capacity of a battery. In addition, the aromatic polyhydric metal carboxylate can prevent volumetric swelling of the electrode even when repeating charge/discharge cycles, thereby providing the battery with improved life.

The aromatic polyhydric metal carboxylate is advantageous in that it has longer life, higher stability and lower cost, as compared to silicon and transition metal oxides generally referred to as high-capacity negative electrode materials in lithium batteries. Moreover, the aromatic polyhydric metal carboxylate as an organic material is synthesized with ease, and thus shows an advantage of high cost-efficiency.

The negative electrode may be obtained by coating a metal storage host including a metal-containing aromatic compound on a current collector. Particularly, the coating may be carried out by using any one process selected from the group consisting of slurry casting, spray coating, filtration, dry process, sputtering, electroless plating, electro-spraying, evaporation, inkjet printing, imprint lithography, offset printing and 3D printing, but the scope of the present disclosure is not limited thereto.

According to an embodiment of the present disclosure, the electrolyte may include at least one selected from the group consisting of an organic electrolyte, an ionic liquid electrolyte, a gel electrolyte, a polymer electrolyte and an inorganic electrolyte. Any electrolyte may be used, as long as it includes an electrolyte for a metal battery known to those skilled in the art. Particular examples of the electrolyte include a liquid electrolyte containing a metal salt, such as lithium hexafluorophosphate (LiPF₆), lithium bis(oxalato)borate (LiBOB), lithium bis-trifluoromethanesulfonimide (LiTFSI), lithium bis(trifluoromethanesulfonyl)imide (CF₃SO₂)₂NLi), or the like, dissolved in an organic solvent, such as a carbonate-based, ester-based, ether-based, ketone-based, alcohol-based, aprotic solvent or a combination thereof. Metal ions can be supplied and migrated freely through the electrolyte, and thus ion migration can be accelerated.

According to an embodiment of the present disclosure, the metal battery may further include a separator interposed between the positive electrode and the negative electrode. Any separator may be used with no particular limitation, as long as it is disposed between the positive electrode and the negative electrode to interrupt both electrodes from being in contact with each other and includes a material through which metal ions can pass smoothly. Typical examples of the separator include a porous membrane, including polyolefin such as polypropylene.

Hereinafter, the present disclosure will be explained in more detail with reference to Examples.

### Example 1

Lithium terephthalate (Li₂TP) as a metal-containing aromatic compound, carbon black as a conductive material and polyvinylidene fluoride (PVDF) as a binder were mixed at a weight ratio of 60:30:10 to prepare a mixture. The mixture was applied onto a copper current collector through a slurry casting process to form an active material layer having a thickness of 20 μm, thereby providing a negative electrode. Then, the negative electrode, a separator and a positive electrode including lithium iron phosphate (LiFePO₄) as an active material were stacked successively, and an electrolyte was injected thereto, followed by sealing, to obtain a lithium metal battery. The electrolyte was prepared by dissolving lithium bis-trifluoromethanesulfonimide (LiTFSI) in an organic solvent containing dioxolan (DOL) and dimethoxyethane (DME) at a volume ratio of 1:1 to a concentration of 1 M to prepare a non-aqueous electrolyte, and further dissolving 2 wt % of lithium nitrate (LiNO₃) therein based on the weight of the electrolyte.

### Comparative Example 1

A metal battery was obtained in the same manner as Example 1, except that the negative electrode had no active material layer.

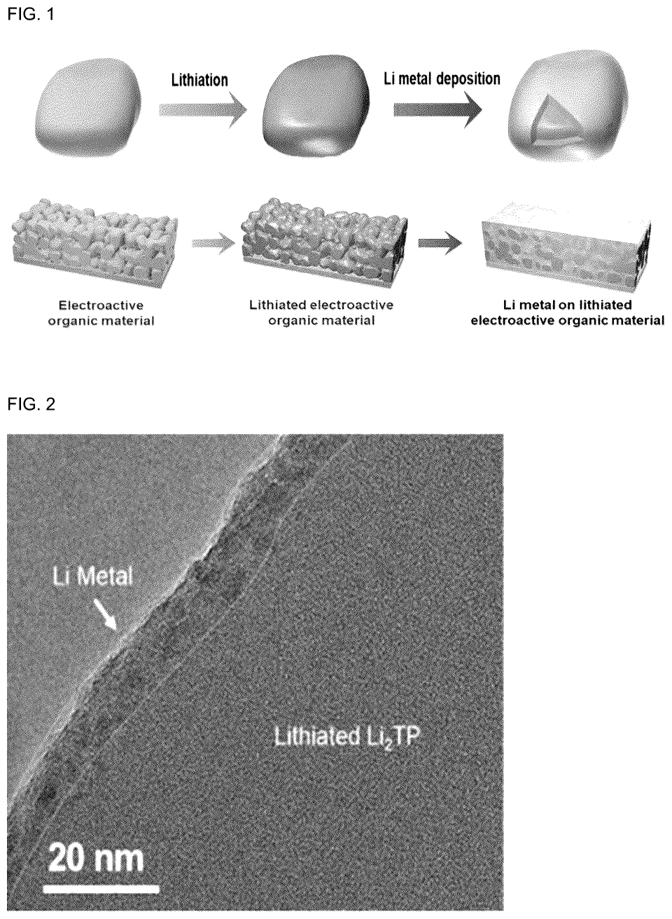

FIG. 1 is a schematic view illustrating the method for manufacturing a metal battery according to Example 1. When the metal battery obtained by applying the active material including lithium terephthalate (Li₂TP) onto the current collector was charged, lithium ions migrated to the negative electrode surface and lithium terephthalate undergo lithiation, which allows deposition of lithium metal on the negative electrode.

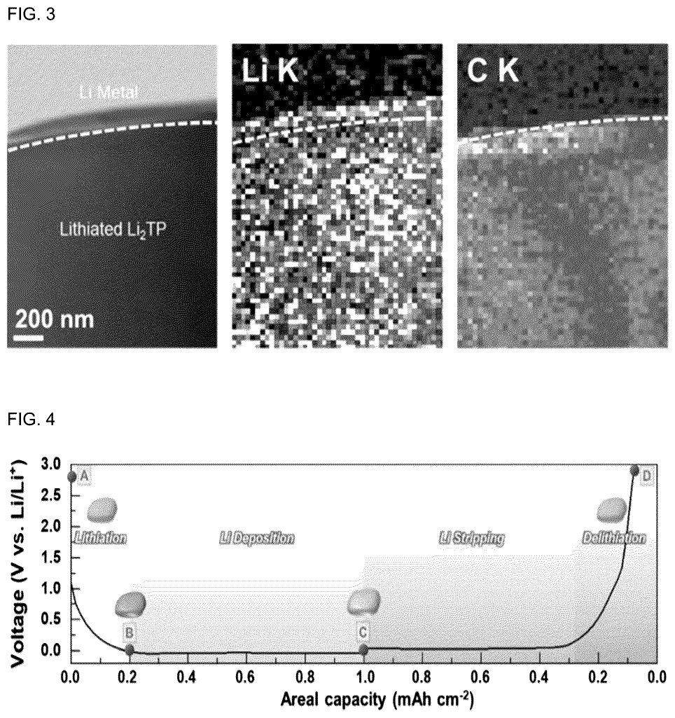

FIG. 2 is a high-resolution transmission electron microscopic (HR-TEM) image of the negative electrode for a metal battery according to the method of Example 1, and FIG. 3 is an image of the negative electrode for a metal battery according to the method of Example 1, as observed by electron energy loss spectroscopy (EELS). It can be seen from FIG. 2 and FIG. 3 that lithium metal is uniformly deposited on lithium terephthalate in the form of foil. Particularly, lithium terephthalate is advantageous in that it provides nucleation sites that assist uniform growth of deposited lithium metal and thus can significantly inhibit dendrite growth on the electrode.

FIG. 4 is a graph illustrating a change in capacity depending on the charge/discharge of the electrode for a metal battery according to Example 1. As the metal battery is charged, lithium metal is deposited on the negative electrode through lithiation. When the metal battery is discharged, lithium deposited on the negative electrode is detached, and delithiation proceeds. Therefore, it can be seen that deposition/detachment of metal occurs reversibly while charge/discharge cycles are carried out continuously. Herein, as dendrite growth is reduced significantly through the uniform deposition of metal on the negative electrode, generation of dead lithium that loses an electric contact with the current collector during discharge can be inhibited. Therefore, the electrolyte is not depleted and reversible deposition/detachment of lithium metal can be repeated, thereby providing the battery with improved life.

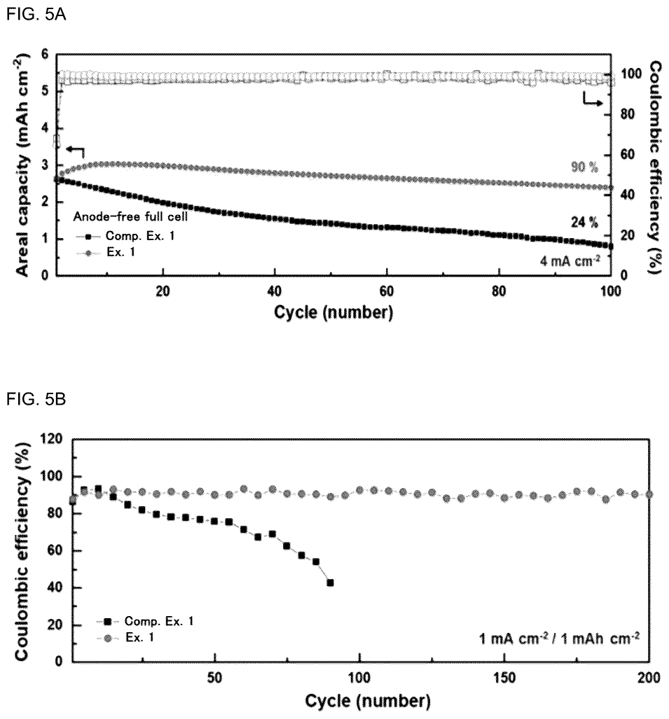

FIGS. 5A and 5B are graphs illustrating the electrochemical performance of a metal battery. FIG. 5A is a graph illustrating the capacity retention and coulombic efficiency of the metal battery according to each of Example 1 and Comparative Example 1, when charge/discharge cycles are repeated at a current rate of 4 mA/cm² by using a charger. It can be seen that the metal battery according to Example 1 shows a capacity retention of up to 90% even though it is repeatedly subjected to charge/discharge cycles 100 times.

On the contrary, the metal battery according to Comparative Example 1 merely has a capacity retention of 24% based on the initial capacity, after 100 cycles, and thus shows significantly reduced life as compared to the metal battery according to Example 1. As described above, when metal is deposited uniformly on the negative electrode, dendrite growth on the metal electrode can be inhibited, metal foil can be reversibly deposited on and detached from the negative electrode, and thus the battery shows a decrease in loss of capacity even after repeating charge/discharge cycles, thereby providing high coulombic efficiency. In addition, since lithium terephthalate directly contributes to improvement of the capacity of the battery, the metal battery according to Example 1 can realize a higher capacity as compared to the metal battery according to Comparative Example 1.

Similarly, as can be seen from FIG. 5B, the metal battery according to Comparative Example 1 causes a short-circuit within about the 100^{th} cycle, when charge/discharge cycles are carried out at a current rate of 1 mA/cm² and a current quantity of 1 mAh/cm², while the metal battery according to Example 1 having improved durability and life through the inhibition of lithium dendrite growth can retain its capacity even after the 200th cycle and can provide excellent coulombic efficiency.

The present disclosure has been described in detail with reference to specific embodiments, examples and drawings. However, it should be understood that the detailed description and specific examples are given by way of illustration only, and thus scope of the present disclosure is not limited thereto. In addition, various changes and modifications within the scope of the disclosure will become apparent to those skilled in the art from this detailed description.

Therefore, the description proposed herein is just a preferable example for the purpose of illustrations only, not intended to limit the scope of the disclosure, so it should be understood that other equivalents and modifications could be made thereto without departing from the scope of the disclosure.

What is claimed is:

1. An electrode for a metal battery, comprising:
a current collector; and
an active material layer disposed on the current collector and comprising a metal storage host,
wherein the metal storage host comprises a metal-containing aromatic compound.

2. The electrode for a metal battery according to claim 1, wherein the metal in the metal-containing aromatic compound comprises lithium.

3. The electrode for a metal battery according to claim 2, wherein the metal-containing aromatic compound comprises an aromatic polyhydric metal carboxylate.

4. The electrode for a metal battery according to claim 3, wherein the aromatic polyhydric carboxylic acid of the aromatic polyhydric metal carboxylate comprises at least one selected from the group consisting of phthalic acid (PA), isophthalic acid (IPA), terephthalic acid (PTA) and naphthalene-2,6-dicarboxylic acid.

5. The electrode for a metal battery according to claim 1, wherein the active material layer further comprises a conductive material and a binder.

6. The electrode for a metal battery according to claim 1, wherein the active material layer has a thickness of 1-100 μm.

7. The electrode for a metal battery according to claim 1, which further comprises metal foil disposed on the active material layer.

8. The electrode for a metal battery according to claim 7, wherein the metal foil has a thickness of 3-18 nm.

9. The electrode for a metal battery according to claim 8, wherein the metal foil comprises lithium.

10. The electrode for a metal battery according to claim 9, wherein the metal foil is deposited through an electrochemical process.

11. A metal battery comprising:
a negative electrode that comprises a metal storage host comprising a metal-containing aromatic compound;
a positive electrode disposed to face the negative electrode while being spaced apart from the negative electrode; and
an electrolyte that is in contact with the positive electrode and the negative electrode.

12. The metal battery according to claim 11, wherein the metal-containing aromatic compound comprises an aromatic polyhydric metal carboxylate.

13. The metal battery according to claim 12, wherein the aromatic polyhydric carboxylic acid of the aromatic polyhydric metal carboxylate comprises a C6-C20 aromatic group and 2-4 carboxylate groups.

14. The metal battery according to claim 11, wherein the electrolyte comprises at least one selected from the group consisting of an organic electrolyte, an ionic liquid electrolyte, a gel electrolyte, a polymer electrolyte and an inorganic electrolyte.

15. The metal battery according to claim 11, which further comprises a separator interposed between the positive electrode and the negative electrode.
